(19) United States
(12) Patent Application Publication
(10) Pub. No.: US 2013/0302026 A1
(43) Pub. Date: Nov. 14, 2013

(54) APPARATUS AND METHOD FOR SEARCHING A COMMUNICATION NETWORK INCLUDING AN ASYMMETRY NODE FOR A ROUTE

(71) Applicant: FUJITSU LIMITED, Kawasaki-shi (JP)

(72) Inventors: Tomohiro Hashiguchi, Inagi (JP); Kazuyuki Tajima, Yokosuka (JP); Yutaka Takita, Kawasaki (JP)

(73) Assignee: FUJITSU LIMITED, Kawasaki-shi (JP)

(21) Appl. No.: 13/799,720

(22) Filed: Mar. 13, 2013

(30) Foreign Application Priority Data
May 8, 2012 (JP) 2012-106582

(51) Int. Cl. H04B 10/038

(52) U.S. Cl. CPC H04B 10/038
USPC 398/2

(57) ABSTRACT

An apparatus searches for one or more first routes coupling starting and ending point nodes in a communication network including an asymmetry node, based on topology information indicating a connection relationship between nodes on the communication network. The apparatus determines, for each of the one or more first routes, whether or not signals are transmittable between the starting and ending point nodes under path restriction imposed on the asymmetry node, based on asymmetry-node information indicating the path restriction imposed on the asymmetry node. The apparatus determines a second route that has a minimum sum of link costs among one or more third routes for which it is determined that signals are transmittable between the starting and ending point nodes under the path restriction imposed on the asymmetry node, based on cost information storing a link cost of a link connecting each pair of adjacent nodes on the communication network.

### CROSS-REFERENCE TO RELATED APPLICATION

This application is based upon and claims the benefit of priority of the prior Japanese Patent Application No. 2012-106582, filed on May 8, 2012, the entire contents of which are incorporated herein by reference.

### FIELD

The embodiments are related to apparatus and method searching a communication network including an asymmetry node for a route.

### BACKGROUND

Recently, in an optical network field, an optical add-drop multiplexer (OADM), a wavelength cross connect (WXC) device, etc. that perform add-drop and route switching of an optical signal in a wavelength unit using the optical signal as-is have been used. Such optical devices allow establishment of a network that has a complicated topology such as interconnection between rings and mesh topology, thereby promoting extension of the scale of the network.

As the extension of the scale of the network progresses, a route search method between nodes is becoming increasingly important. A method is known in which, in a communication network, a set of a distribution server and a distribution route is determined using individual link load states in directions from temporary nodes, which respectively access a plurality of distribution servers through virtual links, to a client-side router (for example, see Japanese Laid-open Patent Publication No. 2007-184969).

FIGS. 1A to 1C are diagrams illustrating examples of a route search method. In the examples of FIGS. 1A to 1C, a case is described in which the shortest route from a starting point node “A” to an ending point node “Z” on a communication network is searched for. First, as illustrated in FIG. 1A, a route search device (not illustrated) calculates cost for a link from the starting point node “A” to an adjacent node “B” and a link from the starting point node “A” to an adjacent node “C”. Here, the cost of the link from the starting point node “A” to the adjacent node “B” is “3”, and the cost of the link from the starting point node “A” to the adjacent node “C” is “1”.

In addition, the route search device manages, for example, “d (P)” that indicates the sum of the link costs from the starting point node “A” to a given node “P”, and “Pre (P)” that indicates the previous node of the given node “P”. In the example of FIG. 1A, “d(A)=0 and Pre (A)=N/A (not applicable)”, “d(B)=3 and Pre(B)=A”, “d(C)=1, Pre(C)=A”, and “d(Z)=∞ and Pre (Z)=N/A” are satisfied.

Next, as illustrated in FIG. 1B, the route search device updates the previous node “Pre (B)” of the node “B” from “A” to “C” and calculates a cost of a link from the node “C” to the node “B”. In the example of FIG. 1B, “d (B)” is updated from “3” to “2” because the cost of the link from the node “C” to the node “B” is “1”. In addition, as illustrated in FIG. 1C, on the basis of the above-described updated d (B) and the cost “1” of the link from the node “B” to the ending point node “Z”, d (Z) is updated to “3”, and Pre (Z) is updated to “B”.

As described above, the route from the starting point node “A” to the ending point node “Z” (see an arrow that is indicated by the broken line in FIG. 1C) is searched for. The route search device determines the above-described route having the minimum sum of the link costs (that is, the route from “A” to “C” to “B” to “Z”) as the shortest route from the starting point node “A” to the ending point node “Z”.

As an example of a conventional algorithm to solve the problem of the route search, there is Dijkstra's algorithm. Dijkstra's algorithm is as illustrated in FIG. 2. In a node to which the WXC device is introduced (hereinafter, simply referred to as a hub node), the routes of optical signals from three or more incoming paths may be switched using the optical signals as-is without converting the optical signals into electrical signals.

However, due to operational constraint of an optical device that is installed in the hub node and constraint under a network operation policy such as restriction of the number of connections between ports, it is probable that connectivity between paths that are connected to the hub node is restricted. For example, as illustrated in FIG. 3, the hub node “B” allows a path from the node “A” to the node “Z” through the hub node “B” and a path from the node “Z” to the node “A” through the hub node “B”, on the other hand, the hub node “B” may not allow a path from the node “C” to the node “Z” through the hub node “B” and a path from the node “Z” to the node “C” through the hub node “B”.

### SUMMARY

According to an aspect of the invention, there is provided an apparatus for searching a communication network including an asymmetry node for a route, where the asymmetry node is a node on which path restriction for restricting a connectable path is imposed. The apparatus stores topology information indicating a connection relationship between nodes on the communication network, cost information storing a link cost of a link connecting each pair of adjacent nodes on the communication network, and asymmetry-node information indicating the path restriction imposed on the asymmetry node. The apparatus searches for one or more first routes coupling a starting point node and an ending point node in the communication network, based on the topology information. The apparatus determines, for each of the one or more first routes, whether or not signals are transmittable between the starting and ending point nodes under the path restriction imposed on the asymmetry node, based on the asymmetry-node information. Then, the apparatus further determines, based on the cost information, a second route that has a minimum sum of the link costs among one or more third routes for which it is determined that signals are transmittable between the starting and ending point nodes under the path restriction imposed on the asymmetry node.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A to 1C are diagrams illustrating an example of a route search method;

FIG. 2 is a diagram illustrating an example of Dijkstra's algorithm;

FIG. 3 is a diagram illustrating an example of an asymmetry node;

FIGS. 4A to 4C are diagrams illustrating an example of a route search method;

FIG. 5 is a diagram illustrating a configuration example of an optical network, according to an embodiment;

FIG. 6 is a diagram illustrating a configuration example of a route search device, according to an embodiment;

FIG. 7 is a diagram illustrating an example of an operational flowchart for searching for a route, according to an embodiment;

FIGS. 8A to 8D are diagrams illustrating an example of a route search method, according to an embodiment;

FIG. 9A is a diagram illustrating an example of a route through which signals are bi-directionally transmittable;

FIG. 9B is a diagram illustrating an example of a route through which signals are not bi-directionally transmittable;

FIG. 10 is a diagram illustrating an example of an operational flowchart for searching for a route, according to an embodiment; and

FIG. 11 is a diagram illustrating an example of a hardware configuration of a route search device, according to an embodiment.

### DESCRIPTION OF EMBODIMENTS

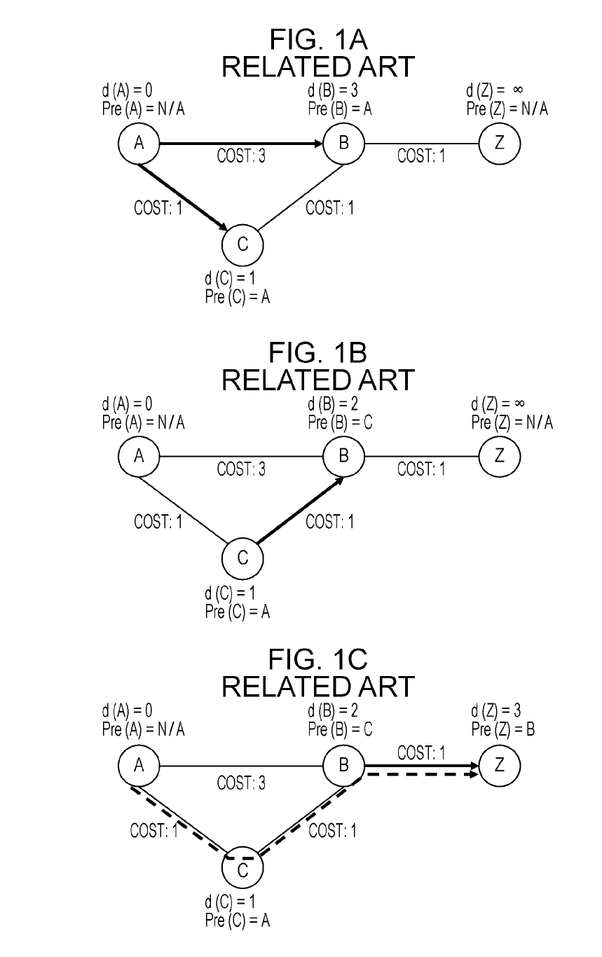

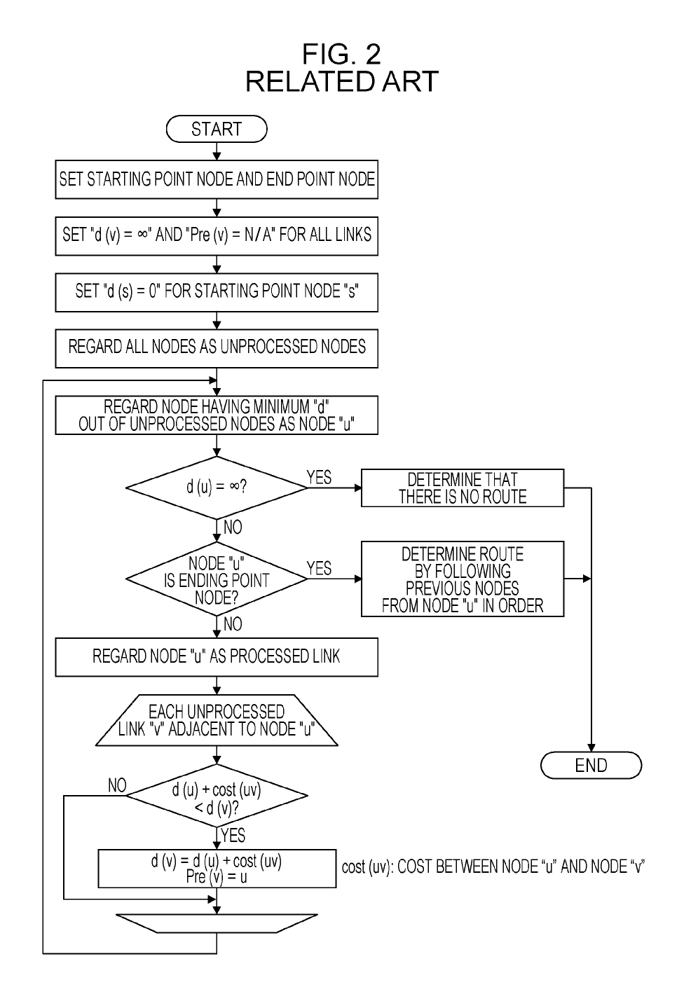

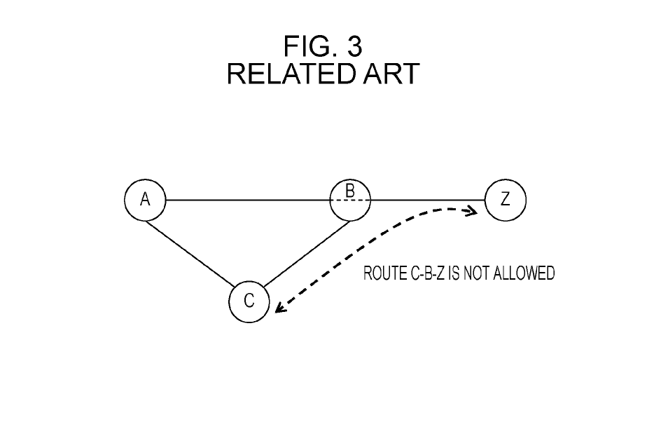

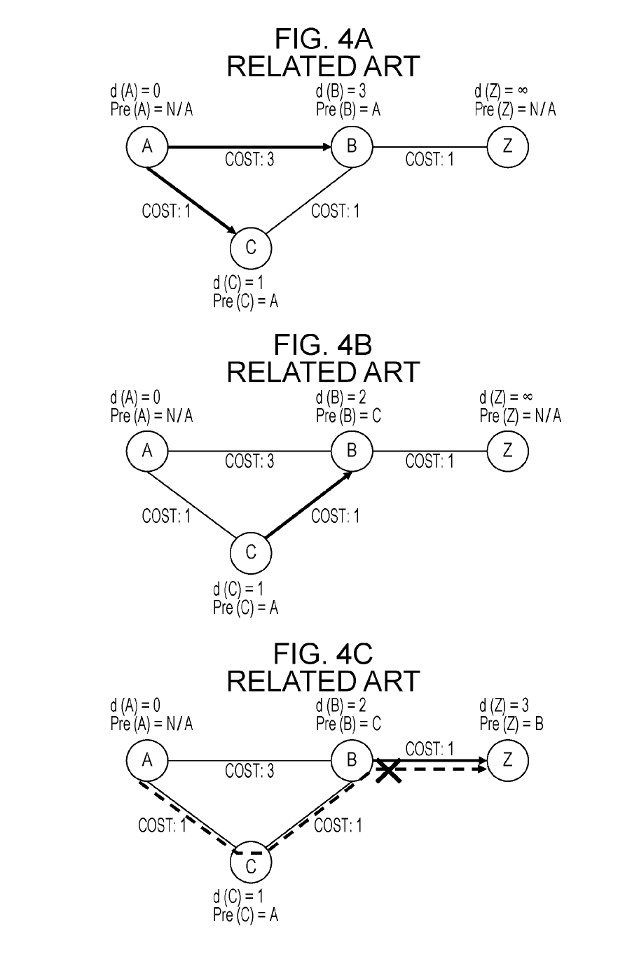

A node with restricted connectivity as described above is also referred to as an asymmetry node. In a case in which there is an asymmetry node (For example, node “B”) on the network, as illustrated in FIGS. 4A to 4C, when shortest route search is performed similarly to the method illustrated in FIGS. 1A to 1C and the conventional Dijkstra's algorithm, it is probable that a route through which an optical signal is not allowed to transmitted (see the broken line arrow of FIG. 4C) is erroneously determined as the shortest route.

The embodiments are described below with reference to drawings. However, the embodiments and modifications that are described below are mere examples, and it is not intended that various modifications and application of the technology that are not clarified in the embodiments and modifications described below are removed. That is, the embodiments and modifications described below may be carried out so as to be variously modified without departing from the scope of the present disclosure.

1. Embodiments

1. 1 Example of a Configuration of Network

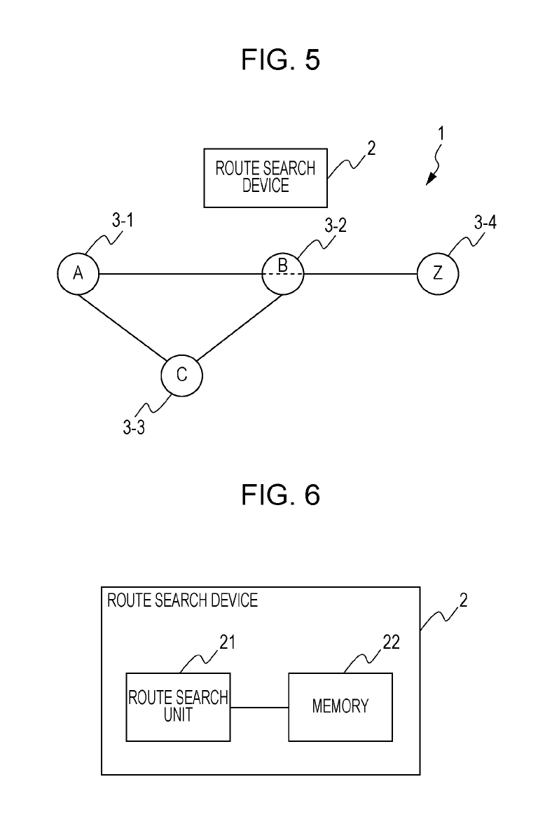

FIG. 5 is diagram illustrating an example of a configuration of a communication network, according to an embodiment.

In a network 1 illustrated in FIG. 5, there are exemplarily included a route search device 2 and transmission devices (nodes) 3-1 to 3-4. Hereinafter, the nodes 3-1, 3-2, 3-3, and 3-4 will be also respectively referred to as a node “A”, a node “B”, a node “C”, and a node “Z”, and will be also simply referred to as a node 3 when the nodes 3-1 to 3-4 are not distinguished. In addition, the number of nodes and the connection configuration (network topology) that are illustrated in FIG. 5 are mere examples, and the number of nodes and a connection configuration are not limited to the example illustrated in FIG. 5.

In the network 1 illustrated in FIG. 5, the node “A” is connected to the node “B” and the node “C”, and the node “B” is connected to the node “C” and the node “Z”. That is, the node “A” is adjacent to the node “B” and the node “C”, and the node “B” is adjacent to the node “A”, the node “C”, and the node “Z”. Here, the node “B” is configured as an asymmetry node in which a connectable path is restricted, so as to allow a path from the node “A” to the node “Z” through the node “B” and a path from the node “Z” to the node “A” through the node “B” and not allow a path from the node “C” to the node “Z” through the node “B” and a path from the node “Z” to the node “C” through the node “B”. The meaning of “restriction of connectable path” includes not only a case in which ports are not connected to each other (path is not established) through a signal transmission line but also a case in which a signal is not allowed to be transmitted (not transmitted) between the ports even the ports are connected to each other through the signal transmission line. The network 1 illustrated in FIG. 5 may be a part of a certain network, which is singled out from the certain network, and in this case, there may exist a route from the node “C” to another node through the node “B”.

The route search device 2 includes a function to search for a route from a given starting point node to a given ending point node. In order to carry out the function, the route search device 2 includes, for example, a route search unit 21 and a memory 22 as illustrated in FIG. 6. The memory 22 stores various pieces of information that is related to the network 1. The information that is stored in the memory 22 includes, for example, topology information that indicates a connection relationship between the nodes 3 in the network 1, cost information that indicates the cost of each link, and asymmetry node information that is related to path restriction imposed on an asymmetry node. For example, the topology information includes information that indicates mutual connection of the nodes 3, the cost information includes information that is related to cost such as a distance and a communication capacity of each link, and the asymmetry node information includes information that is related to restriction of connectivity in the asymmetry node.

The information that is stored in the memory 22 may be input, for example, from a network administrator, a user, etc., to the memory 22. Alternatively, the route search device 2 may collect various pieces of information from each of the nodes 3 and generate information that is stored in the memory 22, on the basis of the collected information. Further, the information that is stored in the memory 22 may be updated, for example, depending on the change of the topology of the network 1 as appropriate. In this case, the information that is stored in the memory 22 may be updated by the network administrator, the user, etc. Alternatively, the route search device 2 may update the information using the various pieces of information that is collected from each of the nodes 3.

The route search unit 21 searches for a route from a given starting point node to a given ending point node, based on the information that is stored in the memory 22. For example, the route search unit 21 searches for a route from the starting point node to the ending point node on the basis of the above-described topology information, determines whether or not a signal is allowed to be transmitted even under the path restriction of the asymmetry node on the route obtained by the search, on the basis of the above-described asymmetry node information, and determines a route having the minimum sum of the costs of links, out of routes for which it is determined that a signal is allowed to be transmitted, on the basis of the above-described cost information.

That is, the route search unit 21 functions as an example of a processing unit that searches for a route from a starting point node to an ending point node on the basis of the topology information, determines whether or not a signal is allowed to be transmitted even under a path restriction of an asymmetry node on the route obtained by the search, on the basis of asymmetry node information, and determines a route having the minimum sum of the costs of links, out of routes for which it is determined a signal is allowed to be transmitted, on the basis of cost information.

An example of the route search method is described below.

1. 2 Example of the Route Search Method

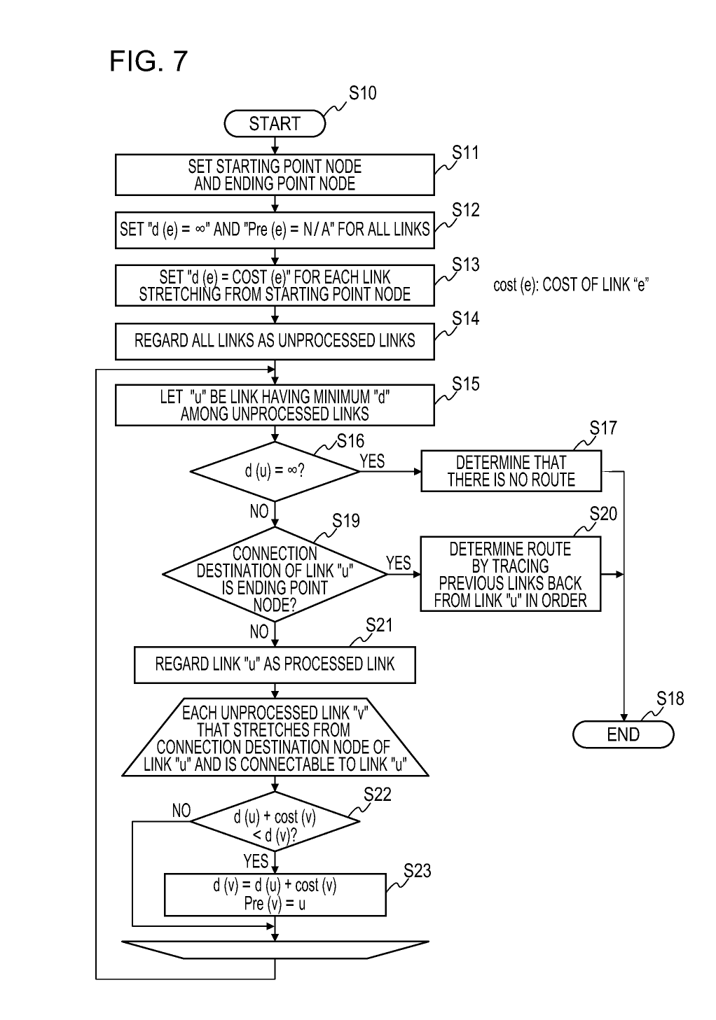

As illustrated in FIG. 7, first, when the route search processing is started (Step S10), the route search unit 21 determines (sets) a starting point node and an ending point node from among a plurality of nodes 3 on the network 1 (Step S11). Here, a node “A” is determined as the starting point node, and a node “Z” is determined as the ending point node.

In addition, the route search unit 21 sets, for each link “e” in the network 1, a value of “d (e)” that indicates the sum of link costs of a route from the starting point node to the link “e” at an infinite value, and sets “Pre (e)” that indicates the previous link of the link “e” on the route as not applicable (N/A) (Step S12). In addition, the route search unit 21 sets, for each of the links “e” stretching from the starting point node, a value of “d” as the link cost (Step S13). That is, “d(e)=cost (e)” is set. The cost (e) may be set when the route search unit 21 reads the cost (e) from the memory 22.

Next, the route search unit 21 sets all links as unprocessed links (Step S14). Then, the route search unit 21 lets “u” denote a link having the minimum “d” among the unprocessed links (Step S15). Here, the route search unit 21 determines whether or not “d(u)=∞” is satisfied (Step S16).

When “d(u)=∞” is satisfied (Yes in Step S16), the route search unit 21 determines that there exists no route from the starting point node to the ending point node (Step S17), and terminates the processing (Step S18). On the other hand, when “d(u)=∞” is not satisfied (No in Step S16), the route search unit 21 determines whether or not a connection destination node of the link “u” is the ending point node (Step S19).

When it is determined that the connection destination node of the link “u” is the ending point node (Yes in Step S19), the route search unit 21 determines a route by tracing the previous links back from the link “u” in order (Step S20) and terminates the processing (Step S18). On the other hand, when it is determined that the connection destination node of the link “u” is not the ending point node (No in Step S19), the route search unit 21 regards the link “u” as a processed link (Step S21) and determines whether or not a value of “d(u)+cost(v)” is smaller than “d (v)”, for each unprocessed link “v” that stretches from the connection destination node of the link “u” and is connectable to the link “u” (Step S22).

That is, the route search unit 21 investigates routes between the starting point node and the ending point node by omitting a route including a path for which connection is not allowed. Here, when the value of “d (u)+cost (v)” is smaller than “d (v)” (Yes in Step S22), the route search unit 21 sets “d (v)=d(u)+cost (v)” and “Pre(v)=u” (Step S23).

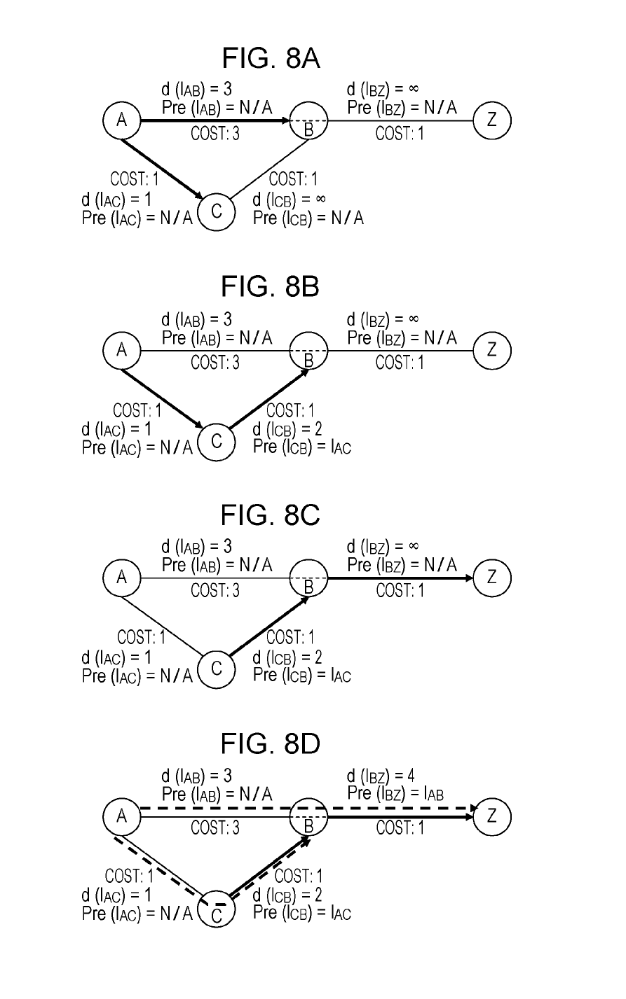

On the other hand, when the value of “d(u)+cost(v)” is “d (v)” or more (No in Step S22), the route search unit 21 omits (skips) the processing of Step S23. Each of the pieces of processing of the above-described Steps S22 and S23 is executed for each of the unprocessed links “v” that stretch from the connection destination node of the link “u” and that are connectable to the link “u”. An example of the route search method illustrated in FIG. 7 is described with reference to FIGS. 8A to 8D.

First, as illustrated in FIG. 8A, for the links I_{AB} and I_{AC} that stretch from the starting point node “A”, “d(I_{AB})=3” and “d(I_{AC})=1” are determined. Next, as illustrated in FIG. 8B, as the first link “u”, the link I_{AC} from the node “A” to the node “C” is selected, and for an unprocessed link I_{CB} that is connectable to the link I_{AC}, “d(I_{CB})=2” and “Pre(I_{CB})=I_{AC}” are determined.

In addition, as illustrated in FIG. 8C, as the link “u”, the I_{CB} is selected where the asymmetry node “B” is an asymmetry node on which, for example, the path restriction is imposed so as to allow a path from the node “A” to the node “Z” through the node “B” and a path from the node “Z” to the node “A” through the node “B” and not allow a path from the node “C” to the node “Z” through the node “B” and a path from the node “Z” to the node “C” through the node “B”. In this case, “d (I_{BZ})” is not updated because connection between the links I_{CB} and the I_{BZ} is not allowed.

Next, as illustrated in FIG. 8D, the link “I_{BZ}” is selected as the link “u”, and the route search unit 21 terminates the processing because the connection destination node is the ending point node “Z”. Here, an intended route is determined by tracing the link “Pre(I_{BZ})=I_{AB}”. That is, a route from the node “A” to the node “B” to the node “Z” is determined as the intended route.

As described above, according to this example, even in the network 1 including the asymmetry node, a route that couples the starting point node and the ending point node is searched for appropriately.

2. Modification

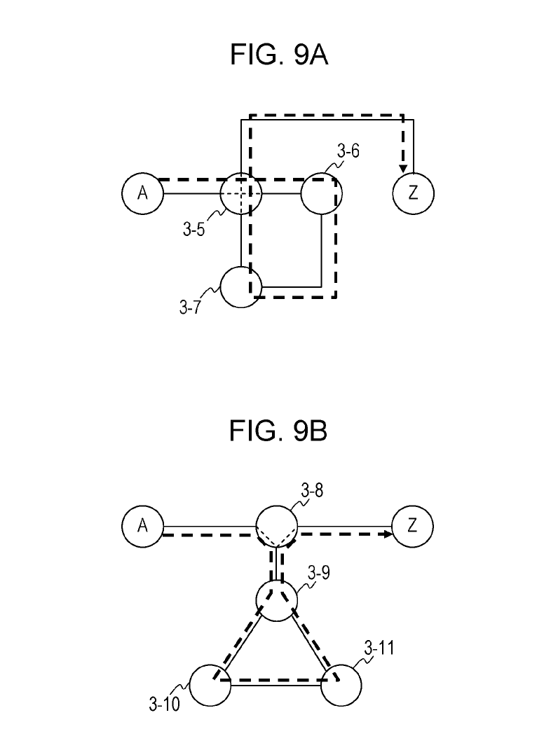

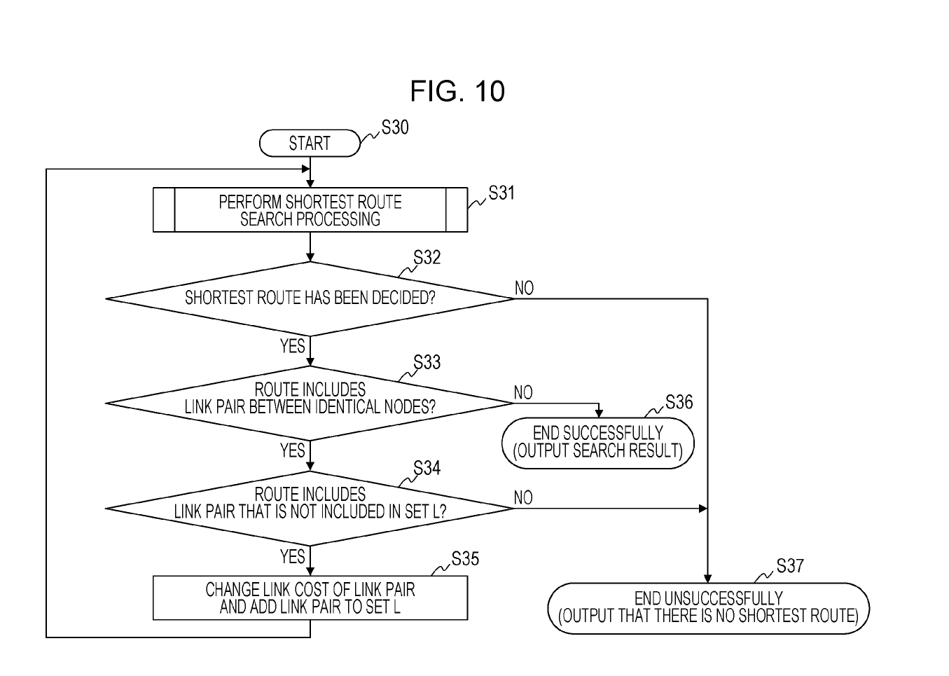

A route obtained by the above-described route search method may include a sub-route that is indicated by the broken line arrow of FIG. 9A or 9B. In the network 1, when a sub-route from a starting point node “A” to an ending point node “Z” is set, in order to secure bidirectionality of an optical signal, it is desirable that the optical signal is allowed to be transmitted through the sub-route in the both directions from the starting point node “A” to an ending point node “Z” and from the ending point node “Z” to the starting point node “A”.

A first sub-route that is indicated by the broken line arrow of the FIG. 9A is a sub-route from the starting point node “A” to the ending point node “Z” through a node 3-5, node 3-6, a node 3-7, and the node 3-5 in this order. The first sub-route is a “trail” that passes through the node 3-5 twice and passes through each link between the nodes 3 once at a maximum, and bidirectionality of an optical signal is secured between the starting point node “A” and the ending point node “Z”.

On the other hand, a second sub-route that is indicated by the broken line arrow of FIG. 9B is a sub-route from the starting point node “A” to the ending point node “Z” through a node 3-8, a node 3-9, a node 3-10, a node 3-11, the node 3-9, and the node 3-8 in this order. The bidirectionality of an optical signal is not secured between the starting point node “A” and the ending point node “Z” because the second sub-route passes through a section between the nodes 3-8 and 3-9 twice.

A first segment of the second sub-route from the node 3-8 to the node 3-9 and a second segment of the second sub-route from the node 3-9 to the node 3-8 are distinguished from one another and each pass through different one of links between the nodes 3-8 and 3-9. Therefore, the second sub-route that is indicated by the broken line arrow of FIG. 9B has a feature in common with the first sub-route that is indicated by the broken line arrow of FIG. 9A in respect that both the first and second sub-routes are regarded as a “trail”. However, in a first direction along the second sub-route from the starting point node “A” to the ending point node “Z” through the nodes 3-8, 3-9, 3-10, 3-11, 3-9, and 3-8 in this order, a pair of links from the node 3-8 to the node 3-9 and a data-link from the node 3-9 to the node 3-8 are used. Therefore, when an optical signal is transmitted along the second sub-route in the first direction while another optical signal is transmitted along the same second-sub-route in a second direction from the ending point node “Z” to the starting point node “A” through the nodes 3-8, 3-9, 3-11, 3-10, 3-9, and 3-8 in this order, the optical signals in the first and second directions are not distinguished in a section connecting the nodes 3-8 and 3-9. As a result, the bidirectionality is not secured in the second sub-route that is indicated by the broken line arrow of FIG. 9B.

Therefore, in the embodiment, there is proposed a method of searching for a route while removing a sub-route including a link pair through which an optical signal travels forth and back between nodes, such as links between the nodes 3-8 and 3-9 as illustrated in FIG. 9B.

For example, as illustrated in FIG. 10, first, when route search processing is started (Step S30), the route search unit 21 executes the route search processing by the method illustrated in FIG. 7 (Step S31).

Here, the route search unit 21 determines whether or not the shortest route has been decided (Step S32), and when the shortest route is not decided (No in Step S32), the route search unit 21 determines that there is no shortest route that couples the starting point node and the ending point node and terminates the processing (Step S37). On the other hand, when the shortest route is decided (Yes in Step S32), the route search unit 21 determines whether or not the route includes a link pair between nodes as illustrated in FIG. 9B (Step S33).

Here, when the route that is decided in Step S31 does not include the link pair (No in Step S33), the route search unit 21 outputs the route that is decided in Step S31 as the shortest route that connects the starting point node and the ending point node and terminates the processing (Step S36). On the other hand, the route that is decided in Step S31 includes a link pair (Yes in Step S33), the route search unit 21 determines whether or not the route includes a link pair that is not included in a set L (Step S34). An initial value of the set L is an empty set.

Thus, in the processing of first Step S34, it is determined that the route that is decided in Step S31 includes a link pair that is not included in the set L (Yes in Step S34). In this case, the route search unit 21 changes link cost of the link pair, adds the link pair after the cost change to the above-described set L (Step S35), and causes the processing to proceed to the above-described Step S31.

Here, in second or subsequent Step S31, it is desirable that, for example, the link cost of the link pair is changed to a value so that a route including the link pair is not searched for as the shortest route. For example, the above-described link cost of the link pair may be changed to a value that is large enough as compared with another link cost. As a more reliable method, for example, the above-described link cost of the link pair may be changed to the sum of the costs of all links on the network. As a result, the route including the link pair is not determined as the shortest route because the sum of the link costs in the route including the link pair is typically always greater than the sum of the link costs in another route.

On the contrary, it is determined that the route that is decided in Step S31 includes a link pair that is included in the set L (No in Step S34), the route search unit 21 determines that any one of the routes that are searched for in Step S31 includes a link pair as illustrated in FIG. 9B, determines that there is no shortest route that couples the starting point node and the ending point node, and terminates the processing (Step S37).

As described above, according to this example, a route in which bidirectionality of an optical signal is not secured may be removed from a search result of the shortest route, so that the shortest route on the network may be searched for further appropriately. In addition, when the above-described route search method is not used, routes need to be searched for comprehensively, and a calculation amount increased as compared with this embodiment in which limited combinations are investigated in ascending order of costs.

3. Example of a Hardware Configuration

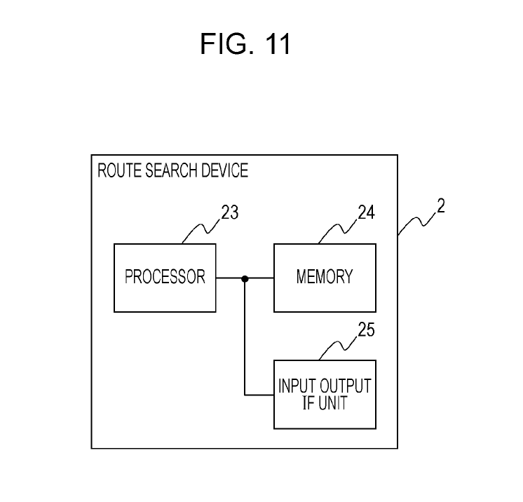

FIG. 11 is a diagram illustrating an example of a hardware configuration of the route search device 2. As illustrated in FIG. 11, the route search device 2 exemplarily includes a processor 23, a memory 24, and an input output interface (IF) unit 25. The processor 23 is a device that processes data and includes, for example, a central processing unit (CPU) and a digital signal processor (DSP).

The memory 24 is a device that stores data and includes, for example, a read only memory (ROM) a random access memory (RAM), a hardware disk drive, and a solid state drive (SSD). The input output IF unit 25 is a device that performs input output and includes, for example, an operation button, a microphone, a drive that is able to read a recording medium, a display, and a speaker.

A correspondence relationship between each of the configurations of the route search device 2 illustrated in FIG. 6 and each of the configurations of the route search device 2 illustrated in FIG. 11 is, for example, as follows. The route search unit 21 corresponds, for example, to the processor 23, the memory 24, and the input output IF unit 25, and the memory 22 corresponds, for example, to the memory 24. A function as the above-described route search device 2 may be realized by executing a certain program by the processor 23 or realized by executing the certain program by a computer (including a CPU, an information processing apparatus, and various terminals) that is installed on the route search device 2.

That is, the above-described program is an example of a route search program that causes a computer to execute processing to search for a route from a starting point node to an ending point node on the basis of topology information that indicates a connection relationship between nodes on the network in which a plurality of nodes including an asymmetry node in which a connectable path is restricted are connected to each other through links, determine whether or not an optical signal is allowed to be transmitted even under path restriction of the asymmetry node in the route that is obtained by the search, on the basis of asymmetry node information that is related to the path restriction of the asymmetry node, and determine a route having the minimum sum of the link costs, out of routes for which it is determined the signal is allowed to be transmitted, on the basis of cost information that indicates cost of each link.

The above-described program may be provided in a form to be recorded in a computer readable recording medium such as a flexible disk, a CD including a CD-ROM, a CD-R, and a CD-RW, and a DVD including a DVD-ROM, a DVD-RAM, a DVD-R, a DVD-RW, a DVD+R, and a DVD+RW. In this case, the above-described program is read from the recording medium through the processor 23 and the input output IF unit 25, and transferred to and stored in the memory 24 to use the program. In addition, the program may be recorded, for example, in a storage device (recording medium) such as a magnetic disk, an optical disk, and an optical magnetic disk, and provided to a computer from the storage device through a communication line. As the recording medium, various computer-readable media may be employed such as an IC card, a ROM cartridge, a magnetic tape, a punch card, an internal storage device of a computer (memory of a RAM, a ROM, etc.), an external storage device, a printed matter to which a symbol such as a bar code is printed, in addition to the above-described flexible disk, CD, DVD, magnetic disk, optical disk, and optical magnetic disk.

4. Others

Each of the configurations and functions of the route search device 2 according to the above-described embodiments and modifications may be decided to be adopted or rejected as appropriate and may be combined as appropriate. That is, each of the above-described configurations and functions may be decided to be adopted or rejected and may be combined as appropriate so that the function according to the embodiments is exerted.

Although the route search method according to the above-described embodiments and modifications is described using the examples in which the network 1 is an optical network, there may exist an asymmetry node even in a network having another communication system due to constraint on the operation policy of the network administrator. Therefore, the route search method according to the above-described embodiments and modifications may be applied to a network having another communication system such as a wireless communication system, and the shortest route between given nodes on the network having the communication system such as the wireless communication system may be searched for appropriately.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An apparatus for searching a communication network including an asymmetry node for a route, the asymmetry node being a node on which path restriction for restricting a connectable path is imposed, the apparatus comprising:
a memory configured to store topology information indicating a connection relationship between nodes on the communication network, cost information storing a link cost of a link connecting each pair of adjacent nodes on the communication network, and asymmetry-node information indicating the path restriction imposed on the asymmetry node; and
a processor configured:
to search for one or more first routes coupling a starting point node and an ending point node in the communication network, based on the topology information,
to determine, for each of the one or more first routes, whether or not signals are transmittable between the starting and ending point nodes under the path restriction imposed on the asymmetry node, based on the asymmetry-node information, and
to determine, based on the cost information, a second route that has a minimum sum of the link costs among one or more third routes for which it is determined that signals are transmittable between the starting and ending point nodes under the path restriction imposed on the asymmetry node.

2. The apparatus of claim 1, wherein
the processor determines, for each of the one or more first routes, whether or not signals are transmittable between the starting and ending point nodes under the path restriction imposed on the asymmetry node, based on the asymmetry node information and information on links of the asymmetry node that are included in the each first route.

3. The apparatus of claim 1, wherein
the processor determines whether or not the second route includes a first pair of links connecting adjacent nodes between which signals travel forth and back;
the processor changes the cost information stored in the memory by increasing link costs of the first pair of links when it is determined that the second route includes the first pair of links; and
the processor determines, based on the changed cost information, a fourth route that has a minimum sum of link costs among the one or more third routes.

4. The apparatus of claim 3, wherein
the processor determines whether or not the fourth route includes the first pair of links; and
the processor determines, when it is determined that the fourth route includes the first pair of links, that there exists no route through which signals are transmittable between the starting and ending point nodes under the path restriction imposed on the asymmetry node.

5. The apparatus claim 3, wherein
the processor performs a repetition process including:
determining whether or not the fourth route includes the first pair of links;
changing the cost information stored in the memory by increasing link costs of the first pair of links when it is determined that the fourth route includes the first pair of links; and
determining, based on the changed cost information, a fifth route that has a minimum sum of link costs among the one or more third routes.

6. The apparatus of claim 3, wherein
the processor changes link costs of the first pair of links to a sum of link costs of all links included in the communication network.

7. A method for searching a communication network including an asymmetry node for a route, the asymmetry node being a node on which path restriction for restricting a connectable path is imposed, the method comprising:
searching for one or more first routes coupling a starting point node and an ending point node in the communication network, based on topology information indicating a connection relationship between nodes on the communication network;
determining, for each of the one or more first routes, whether or not signals are transmittable between the starting and ending point nodes under the path restriction imposed on the asymmetry node, based on asymmetry node information indicating the path restriction imposed on the asymmetry node; and
determining a second route that has a minimum sum of link costs among one or more third routes for which it is determined that signals are transmittable between the starting and ending point nodes under the path restriction imposed on the asymmetry node, based on cost information storing a link cost of a link connecting each pair of adjacent nodes on the communication network.

8. The method of claim 7, further comprising
determining, for each of the one or more first routes, whether or not signals are transmittable between the starting and ending point nodes under the path restriction imposed on the asymmetry node, based on the asymmetry node information and information on links of the asymmetry node that are included in the each first route.

9. The method of claim 7, further comprising:
determining whether or not the second route includes a first pair of links connecting adjacent nodes between which signals travel forth and back;
changing the cost information by increasing link costs of the first pair of links when it is determined that the second route includes the first pair of links; and
determining, based on the changed cost information, a fourth route that has a minimum sum of link costs among the one or more third routes.

10. The method of claim 9, further comprising:
determining whether or not the fourth route includes the first pair of links; and
determining, when it is determined that the fourth route includes the first pair of links, that there exists no route through which signals are transmittable between the starting and ending point nodes under the path restriction imposed on the asymmetry node.

11. The method of claim 9, further comprising
performing a repetition process including:
determining whether or not the fourth route includes the first pair of links;
changing the cost information by increasing link costs of the first pair of links when it is determined that the fourth route includes the first pair of links; and
determining, based on the changed cost information, a fifth route that has a minimum sum of the link costs among the one or more third routes.

12. The method of claims 9, further comprising
changing link costs of the first pair of links to a sum of link costs of all links included in the communication network.

13. A computer readable recording medium having stored therein a program causing a computer to execute a search process for searching a communication network including an asymmetry node for a route, the asymmetry node being a node on which path restriction for restricting a connectable path is imposed, the search process comprising:
searching for one or more first routes coupling a starting point node and an ending point node in the communication network, based on topology information indicating a connection relationship between nodes on the communication network;
determining, for each of the one or more first routes, whether or not signals are transmittable between the starting and ending point nodes under the path restriction imposed on the asymmetry node, based on asymmetry node information indicating the path restriction imposed on the asymmetry node; and
determining a second route that has a minimum sum of link costs among one or more third routes for which it is determined that signals are transmittable between the starting and ending point nodes under the path restriction imposed on the asymmetry node, based on cost information storing a link cost of a link connecting each pair of adjacent nodes on the communication network.

14. The computer readable recording medium of claim 13, wherein the search process further comprises
determining, for each of the one or more first routes, whether or not signals are transmittable between the starting and ending point nodes under the path restriction imposed on the asymmetry node, based on the asymmetry node information and information on links of the asymmetry node that are included in the each first route.

15. The computer readable recording medium of claim 13, wherein the search process further comprises:
determining whether or not the third route includes a first pair of links connecting adjacent nodes between which signals travel forth and back;
changing the cost information by increasing link costs of the first pair of links when it is determined that the second route includes the first pair of links; and
determining, based on the changed cost information, a fourth route that has a minimum sum of link costs among the one or more third routes.

16. The computer readable recording medium of claim 15, wherein the search process further comprises:
determining whether or not the fourth route includes the first pair of links; and
determining, when it is determined that the fourth route includes the first pair of links, that there exists no route through which signals are transmittable between the starting and ending point nodes under the path restriction imposed on the asymmetry node.

17. The computer readable recording medium of claim 15, wherein the search process further comprises
performing a repetition process including:
determining whether or not the fourth route includes the first pair of links;
changing the cost information by increasing link costs of the first pair of links when it is determined that the fourth route includes the first pair of links; and
determining, based on the changed cost information, a fifth route that has a minimum sum of link costs among the one or more third routes.

18. The computer readable recording medium of claim 15, wherein the search process further comprises
changing link costs of the first pair of links to a sum of link costs of all links included in the communication network.
